(19) United States
(12) Patent Application Publication
(10) Pub. No.: US 2012/0075270 A1
(43) Pub. Date: Mar. 29, 2012

(54) LIQUID CRYSTAL DISPLAY DEVICE

(75) Inventor: Hidehito Kitakado, Osaka (JP)

(73) Assignee: SHARP KABUSHIKI KAISHA, Osaka (JP)

(21) Appl. No.: 13/322,653

(22) PCT Filed: Mar. 8, 2010
(86) PCT No.: PCT/JP2010/001619

§ 371 Date: Nov. 28, 2011

(30) Foreign Application Priority Data
Jun. 3, 2009 (JP) 2009-134063

(51) Int. Cl. G09G 3/36; G09G 5/00

(52) U.S. Cl. 345/204; 345/92

(57) ABSTRACT

Provided is a liquid crystal display device that can reduce the power supply voltage and the power consumption of the liquid crystal display device. A liquid crystal display device according to the present invention is a reflective liquid crystal display device having a built-in pixel memory. In a thin film transistor 10 constituting a driver circuit of the liquid crystal display device of the present invention, a gate electrode 16 and two source/drain electrodes 19 block external light in order to prevent external light entering from the surroundings of the liquid crystal display device from entering a portion of gate insulating films 14 and 15 disposed above a channel region 13b.

### TECHNICAL FIELD

The present invention relates to a liquid crystal display device that can lower the power supply voltage and reduce the power consumption.

### BACKGROUND ART

In recent years, in mobile terminals, which are represented by mobile phones, there has been a problem of increased power consumption as a consequence of mobile terminals having multiple functions. Consequently, in order to reduce the power consumption of mobile terminals as much as possible, power conservation in a liquid crystal display device constituting a display section, which particularly consumes a large amount of power, has been in progress.

In order to reduce the power consumption in a liquid crystal display device, when a screen having a fewer changes of image, such as time display or the like, is displayed in a mobile phone, for example, the period for writing an image signal into a liquid crystal capacitance inside a pixel formation unit for displaying pixels is extended.

However, if the period for writing an image signal into a liquid crystal capacitance is extended, the applied voltage needs to be stored in the liquid crystal capacitance for a long time.

Because of this, in the liquid crystal display device mentioned above, a circuit having a memory function (hereinafter referred to as a “pixel memory circuit”) is provided in each pixel formation unit so that the voltage applied to the liquid crystal capacitance is stored for a certain amount of time.

On the other hand, like the above-mentioned mobile terminals, liquid crystal display devices for outdoor public use or for control operation use, high-definition image liquid crystal display devices, which are represented by high-definition broadcasting standards and SVGA standards for computer graphics, and the like have been widely used.

These types of liquid crystal display devices are broadly divided into transmissive liquid crystal display devices, which use a transmissive method, and reflective liquid crystal display devices, which use a reflective method. In the case of the former, transmissive liquid crystal display devices have a disadvantage that the aperture ratio is reduced because regions of TFTs (Thin Film Transistors) provided in the respective pixels do not become transmissive regions of the pixels that transmit light. As a result, the latter reflective liquid crystal display devices are attracting attention.

Generally, in a reflective liquid crystal display device, a plurality of switching elements are disposed such that they are electrically disconnected from one another on a semiconductor substrate (Si substrate). In the uppermost layer of a multilayer film, which is layered above the plurality of switching elements, a plurality of reflective pixel electrodes corresponding to the plurality of switching elements are disposed such that they are electrically disconnected from one another.

A reflective pixel electrode connected to a switching element and a storage capacitance unit for the switching element become a set to form a pixel. A plurality of these pixels are arranged in a matrix on the semiconductor substrate.

A transparent opposite electrode, which is shared by all pixels, is deposited to form a film on a lower surface of a transparent substrate (glass substrate) to face the plurality of reflective pixel electrodes. Liquid crystal is encapsulated between the plurality of reflective pixel electrodes and the opposite electrode.

Light entering from the transparent substrate side enters the liquid crystal through the opposite electrode. This incident light is optically modulated in the liquid crystal according to signals from the respective switching elements. The light is then reflected by the plurality of reflective pixel electrodes, and is emitted as read-out light from the transparent substrate side.

Here, power consumption can be significantly reduced by including the above-mentioned pixel memory circuit in such a reflective liquid crystal display device. Thus, in a reflective liquid crystal display having a built-in pixel memory, a significant reduction in power consumption can be achieved for the following reasons.

Generally, 80% or more of the power consumed by a liquid crystal display device is attributed to use of its backlight. Furthermore, inside its liquid crystal panel, most of the power consumed is used for charging and discharging a signal line required for sending image signals to pixels.

In contrast, in a reflective liquid crystal display device having a built-in pixel memory, a backlight, which causes an increase in power consumption, is not needed. Furthermore, because of the built-in pixel memory circuit, charging and discharging of a signal line is not required when a still image is displayed. As a result, the reflective liquid crystal display device having a built-in pixel memory can reduce its power consumption significantly for these two reasons.

In a current reflective liquid crystal display device having a built-in pixel memory, a circuit inside a pixel and a peripheral driver circuit are driven using a single power supply of 5V, for example. However, in order to achieve a further reduction in power consumption, the power supply voltage for driving the circuit inside the pixel and the peripheral driver circuit needs to be lowered.

In order to lower the power supply voltage, in other words, in order to lower the voltage of thin film transistors (TFTs), the threshold voltage of the thin film transistors needs to be lowered. To achieve this, a gate insulating film of the thin film transistors needs to be made thinner.

This is because the threshold voltage of the thin film transistors is substantially proportional to the subthreshold coefficient of the transistors, and the thinner the film thickness of the gate insulating film, the smaller this subthreshold coefficient becomes. Thus, by making the film thickness of the gate insulating film thinner, the subthreshold coefficient is lowered. By doing so, an increase in the threshold voltage of the thin film transistors can be prevented, and lowering of the threshold voltage can be achieved.

However, a silicon film used in a current TFT is polycrystallized generally by excimer laser light irradiation. Because of this, protrusions called “silicon ridges” are generally formed on a surface of the silicon film.

When these silicon ridges are formed, they cause breakdown voltage defects of the gate insulating film that is made thin, which would lead to an occurrence of leakage current through the gate insulating film and destruction of the gate insulating film itself. These issues are causes of defects of thin film transistors and its signal storage capacitance.

In order to address these problems, a configuration in which a gate insulating film has a two-layer configuration such as a two-layer configuration of a silicon dioxide film and a high permittivity film, for example, that does not lower the capacitance of the gate insulating film and that can increase the film thickness of the gate insulating film has been proposed (see Patent Document 1, for example).

FIG. 6 shows a configuration of a conventional liquid crystal display device described in Patent Document 1. In this conventional liquid crystal display device 100, step formation films 102 made of a SiO₂ film are formed on an insulating substrate 101 made of an alkali-free glass or the like. In a region over the insulating substrate 101 where the step formation films 102 have not been formed and its surrounding regions, a light shielding film 103 made of a metal having a high melting point such as chrome (Cr) or the like is formed.

Over the step formation films 102 and the light shielding film 103, a buffer layer 104 is formed. The buffer layer 104 has a multilayer configuration formed of two layers, which are a SiN film and a SiO₂ film. Over the buffer layer 104, an island-shaped semiconductor film 105 made of p-Si is formed. Over the buffer layer 104 and the semiconductor film 105, two layers, which are a SiO₂ film and a SiN film, are laminated to form a gate insulating film 106.

Above the gate insulating film 106, gate electrodes 107 made of chrome (Cr) are formed. Above the gate insulating film 106 and the gate electrodes 107, two layers formed of a SiO₂ film and a SiN film are laminated to form an interlayer insulating film 108. Above the interlayer insulating film 108, a source electrode 109a and a drain signal line 109b made of either aluminum (Al) or molybdenum (Mo) are formed.

The source electrode 109a runs through the interlayer insulating film 108 and the gate insulating film 106 so as to reach the semiconductor film 105. The drain signal line 109b runs through the interlayer insulating film 108 and the gate insulating film 106 so as to reach the semiconductor film 105.

Above the interlayer film 108, the source electrode 109a, and the drain signal line 109b, a planarized film 110 made of an organic material is laminated, and above this planarized film 110, a pixel electrode 111 is formed.

This pixel electrode 111 is formed of an ITO (Indium Thin Oxide), which is a transparent conductive film, and runs through the planarized film 110 so as to be connected to the source electrode 109a. The step formation films 102 are not formed at a portion corresponding to the semiconductor film 105. As a result, they form a recess in the region surrounding the semiconductor film 105 to form inclinations in the light shielding film 103.

This light shielding film 103 prevents light from entering a channel region 105d of the semiconductor film 105 from the insulating substrate 101 side. When the light shielding film 103 made of a metal is disposed below the semiconductor film 105, it causes impurity diffusion. Therefore, the buffer layer 104 is disposed between the light shielding film 103 and the semiconductor film 105.

The semiconductor film 105 is constituted of a source region 105a, a drain region 105b, a hybrid region 105c, and two channel regions 105d. The source region 105a is electrically connected to the pixel electrode 111. The drain region 105b is electrically connected to the drain signal line 109b.

The hybrid region 105c is placed directly below a region that is interposed between the two gate electrodes 107, and is a region that functions as both source and drain regions with respect to the two gate electrodes 107 simultaneously. The channel regions 105d are placed directly below the gate electrodes 107.

The source region 105a, the drain region 105b, and the hybrid region 105c are implanted with an impurity, and are activated.

The interlayer insulating film 108 electrically insulates the gate electrodes 107 from the source electrode 109a and the drain signal line 109b. The source electrode 109a electrically connects the pixel electrode 111 to the source region 105a of the semiconductor film 105. The drain signal line 109b is electrically connected to the drain region 105b of the semiconductor film 105 to supply a signal voltage.

This way, in the conventional liquid crystal display device 100, the step formation films 102 are formed to provide a recessed portion in an overlapping region corresponding to the semiconductor film 105 and its peripheries. The light shielding film 103 is formed between the semiconductor film 105 and the recessed portion and portions of the step formation films 102. Therefore, light directly entering the channel regions 105d from the insulating substrate 101 side can be blocked three-dimensionally from the sides.

### RELATED ART DOCUMENTS

### Patent Documents

Patent Document 1: Japanese Patent Application Laid-Open Publication, “Japanese Patent Application Laid-Open Publication No. 2003-8026 (Published on Jan. 10, 2003)”

### SUMMARY OF THE INVENTION

### Problems to be Solved by the Invention

There has been known a phenomenon that the threshold voltage of a thin film transistor increases over time when light is irradiated onto a thin film transistor having a gate insulating film that is formed of a multilayer configuration of two layers while a gate voltage is applied.

Specifically, as shown in FIG. 7, even when the stress time, which is a light irradiation period, is the same, a two-layer gate insulating film has a higher amount of increase in threshold voltage compared to a single-layer gate insulating film.

In a reflective liquid crystal display device, there is no light degradation of a thin film transistor caused by a backlight because there is no backlight. However, the thin film transistor can get degraded by light entering from the front surface of the liquid crystal display device.

In a thin film transistor having a top gate configuration, light entering vertically does not cause a problem because the gate electrode is arranged by self-alignment over a channel. However, light entering obliquely becomes a problem. Electrons excited by this obliquely entering light become trapped by a two-layer gate insulating film at an edge of the gate electrode, and change the threshold voltage.

Particularly, the threshold voltage of a transistor to which a high voltage is applied changes significantly. On the other hand, the threshold voltage of a transistor to which a low voltage is applied does not change significantly. However, in a 3V drive transistor, for example, its threshold voltage increases by 0.1V. This increase in threshold voltage causes approximately 10% degradation of circuit operation. In low voltage drive thin film transistors equipped in a liquid crystal display device having a built-in pixel memory, this degradation of circuit operation becomes a problem.

Such degradation causes a change in threshold voltage towards the positive direction. As a result, in an n-type transistor, electric current drive power is impaired. In a p-type transistor, an increase in leakage current in the subthreshold region becomes a problem.

Not surprisingly, in a conventional liquid crystal display device, the above-mentioned phenomena should be avoided not only in thin film transistors provided in a display section for displaying an image, but also in thin film transistors provided in a driver circuit for controlling image display by the display section.

However, although the conventional liquid crystal display device 100 has a configuration to block light entering thin film transistors provided in a display section from the surroundings, it has absolutely no configuration to block light entering thin film transistors provided in a driver circuit.

Therefore, the above-mentioned phenomena occurred in the thin film transistors provided in the driver circuit, and liquid crystal display by the display section of the liquid crystal display device 100 was not performed accurately.

As a result, it was impossible to lower the threshold voltage of the thin film transistors of the driver circuit, which led to a problem that driving of the liquid crystal display device 100 at a lower power supply voltage and a reduction of the power consumption were not achieved.

To address the above-mentioned problems, an object of the present invention is to provide a liquid crystal display device that can lower the power supply voltage of the liquid crystal display device and that can reduce its power consumption.

### Means for Solving the Problems

In order to achieve the above-mentioned object, a liquid crystal display device according to the present invention is a reflective liquid crystal display device, including: a display section having a plurality of pixels for displaying an image arranged; and a driver section for controlling image display by the display section, each of the plurality of pixels having a storage element for storing a display signal, wherein the driver section is constituted of a plurality of thin film transistors, and wherein each of the plurality of thin film transistors includes the following: a channel region and two source/drain regions arranged to have the channel region therebetween; a gate insulating film that is disposed at least above the channel region and that is formed of a multilayer configuration having a plurality of films; a gate electrode disposed above the gate insulating film; two source/drain electrodes electrically connected to the two source/drain regions, respectively, through a connection wire that runs through the gate insulating film and a first interlayer film disposed over the gate insulating film; and a light shielding film that prevents external light entering the liquid crystal display device from the surroundings of the liquid crystal display device from entering a portion of the gate insulating film disposed above the channel region, thereby blocking the external light.

In the above-mentioned liquid crystal display device, a light shielding film for blocking external light is provided for each of the plurality of thin film transistors constituting the driver section to prevent external light entering from the surroundings of the liquid crystal display device from entering a portion of the gate insulating film disposed above the channel region.

As a result, light irradiation onto the gate insulating film can be prevented. Therefore, the threshold voltage of the thin film transistors can be lowered by forming the gate insulating film of a multilayer configuration constituted of a plurality of films. This way, the power supply voltage of the driver section can be lowered and the power consumption can be reduced. Thus, a liquid crystal display device that can be driven with a low power supply voltage and that can reduce the power consumption can be achieved.

### Effects of the Invention

As described above, in the liquid crystal display device of the present invention, the driver section is formed of a plurality of thin film transistors. Each of the plurality of thin film transistors includes a channel region and two source/drain regions arranged to have the channel region therebetween, a gate insulating film that is disposed at least above the channel region and that is formed of a multilayer configuration having a plurality of films, a gate electrode disposed above the gate insulating film, two source/drain electrodes electrically connected to the two source/drain regions, respectively, through a connection wire that runs through the gate insulating film and a first interlayer film disposed above the gate insulating film, and a light shielding film that prevents external light entering the liquid crystal display device from the surroundings of the liquid crystal display device from entering a portion of the gate insulating film disposed above the channel region, thereby blocking the external light.

Thus, the present invention has effects that the power supply voltage can be lowered and the power consumption can be reduced in a liquid crystal display device.

### BRIEF DESCRIPTION OF THE DRAWINGS

FIG. 1 is a cross-sectional view showing a configuration of a thin film transistor that constitutes a driver circuit of a liquid crystal display device according to Embodiment 1 of the present invention.

FIG. 2 is a cross-sectional view showing a configuration of a thin film transistor that constitutes a driver circuit of a liquid crystal display device according to Embodiment 2 of the present invention.

FIG. 3 is a cross-sectional view showing a configuration of a portion of a driver circuit of a liquid crystal display device according to Embodiment 3 of the present invention.

FIG. 4 is a block diagram showing an overall configuration of a liquid crystal display device according to Embodiment 1 of the present invention.

FIG. 5 is a conceptual diagram of a pixel formation unit of FIG. 4.

FIG. 6 is a drawing showing a configuration of a conventional liquid crystal display device.

FIG. 7 is a graph showing a relationship between a light irradiation period and a fluctuation range of the threshold voltage of thin film transistors.

### DETAILED DESCRIPTION OF EMBODIMENTS

Embodiments of the present invention are described below with reference to figures. To describe the following figures, the same or similar reference characters are given to parts that are the same or similar. Here, in order to facilitate the description, the respective figures referenced below show only the simplified main members that are necessary to describe the present invention among the components of embodiments of the present invention. Therefore, a liquid crystal display device according to the present invention may be provided with appropriate components that are not shown in the respective figures used in this specification as reference. Furthermore, the dimensions of members in the respective figures do not truly represent the dimensions of the actual components, the dimensional ratios of the respective members, or the like.

### Embodiment 1

A liquid crystal display device according to Embodiment 1 of the present invention is a reflective liquid crystal display device, which uses a reflective method in which images are displayed by reflecting light entering from the surroundings without using a backlight.

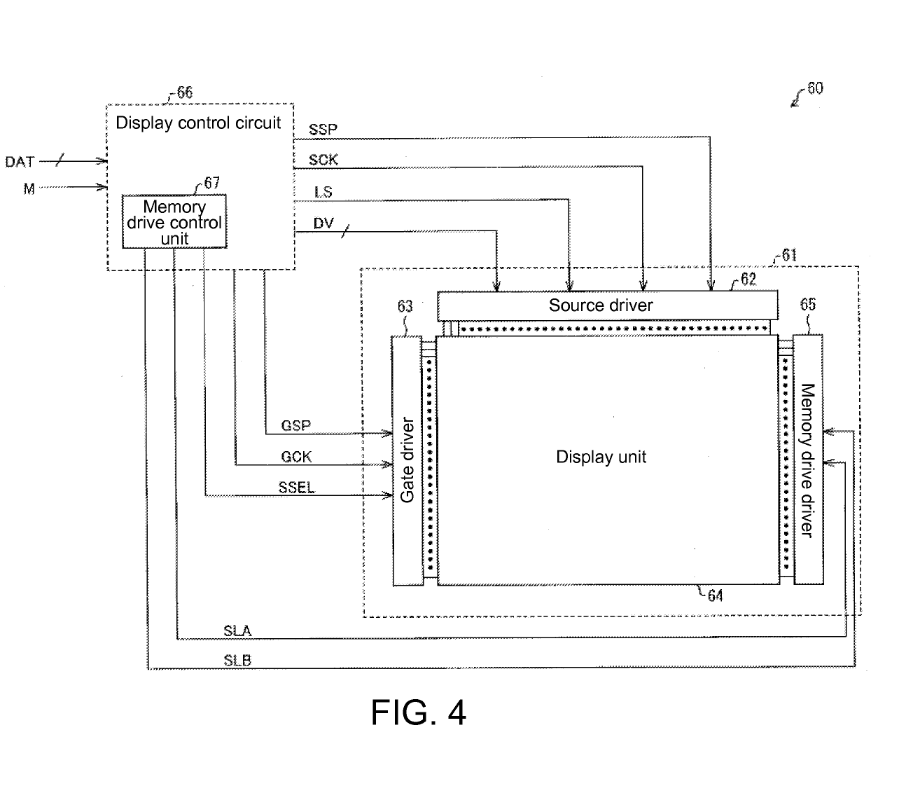

FIG. 4 is a block diagram showing an overall configuration of a liquid crystal display device of Embodiment 1 of the present invention.

As shown in FIG. 4, a liquid crystal display device 60 according to Embodiment 1 of the present invention is provided with a liquid crystal display panel 61 and a display control circuit 66. The liquid crystal display panel 61 has a source driver (driver section) 62, a gate driver (driver section) 63, a display section 64, and a memory drive driver (driver section) 65. The display control circuit 66 has a memory drive control section 67.

The display section 64 includes source bus lines, gate bus lines, memory drive selection lines, a first voltage supply line, a second voltage supply line, a first power supply line, and a second power supply line. Here, the source bus lines are connected to the source driver 62, and the gate bus lines and the memory drive selection lines are connected to the gate driver 63. The first voltage supply line and the second voltage supply line are connected to the memory drive driver 65.

The display section 64 includes a plurality of pixel formation units (pixels) that are respectively provided corresponding to intersections of the gate bus lines and the source bus lines. The respective pixel formation units are formed of a pixel electrode for applying a voltage corresponding to an image to be displayed to a liquid crystal capacitance, a common electrode, which is an opposite electrode provided to be shared by the plurality of pixel formation units, and a liquid crystal layer that is provided to be shared by the plurality of pixel formation units and that is interposed between the pixel electrode and the common electrode.

Furthermore, in the display section 64, if the display section 64 is of a color type, which performs color display, each pixel (hereinafter referred to as a “pixel unit”) constituted of three subpixels for R (red), G (green), and B (blue) is provided with a pixel memory circuit, which is a memory circuit that can store 1 bit data.

In the display section 64, if the display section 64 is of a black and white type, which performs monochrome display, each pixel that has a tripled pixel pitch of the pixel pitch of the respective colors (subpixel pitch) of the color type is provided with the above-mentioned pixel memory circuit.

In the liquid crystal display device 60 of the present embodiment, the driving method can be switched between a “normal drive” and a “memory drive.” The “normal drive” is a driving method that is generally performed in a liquid crystal display device, and is a method by which writing into a liquid crystal capacitance (voltage application) is performed based on an image signal applied to the respective source bus lines. On the other hand, the “memory drive” is a method by which writing into a liquid crystal capacitance is performed based on data stored in a pixel memory circuit.

The display control circuit 66 receives an image data DAT and a display mode command signal M sent from outside, and outputs a digital image signal DV, a source start pulse signal SSP for controlling image display in the display section 64, a source clock signal SCK, a latch strobe signal LS, a gate start pulse signal GSP, a gate clock signal GCK, a first supply voltage control signal SLA, a second supply voltage control signal SLB, and a memory drive control signal SSEL.

The source driver 62 receives the digital image signal DV, the source start pulse signal SSP, the source clock signal SCK, and the latch strobe signal LS, which are outputted from the display control circuit 66, and applies an image signal for driving to the respective source bus lines.

During a normal drive, in order to sequentially select the respective gate bus lines for one horizontal scanning period at a time, the gate driver 63 repeatedly applies an active scan signal to the respective gate bus lines with one vertical scanning period being one cycle based on the gate start pulse signal GSP and the gate clock signal GCK outputted from the display control circuit 66.

When switching from the normal drive to the memory drive, in order to sequentially select the respective gate bus lines for one horizontal scanning period at a time, the gate driver 63 sequentially applies an active scan signal to the respective gate bus lines based on the gate start pulse signal GSP and the gate clock signal GCK outputted from the display control circuit 66. While applying these signals, in order to sequentially select the respective memory drive selection lines for one horizontal scanning period at a time, the gate driver 63 sequentially applies an active signal to the respective memory drive selection lines based on the memory drive control signal SSEL and the gate clock signal GCK outputted from the display control circuit 66. During the memory drive, the gate driver 63 stops applying an active scan signal to the respective gate bus lines, and applies an active signal to all the memory drive selection lines SEL1 to SELm.

The memory drive driver 65 applies voltage signals (VLA, VLB) to the first voltage supply line and the second voltage supply line based on the first supply voltage control signal SLA and the second supply voltage control signal SLB outputted from the display control circuit 66. The above-mentioned voltage signal VLA is a voltage signal that has the phase opposite from that of the opposite voltage, which is applied to the opposite electrode. The above-mentioned voltage signal VLB is a voltage signal that has the same phase as that of the opposite voltage applied to the opposite electrode.

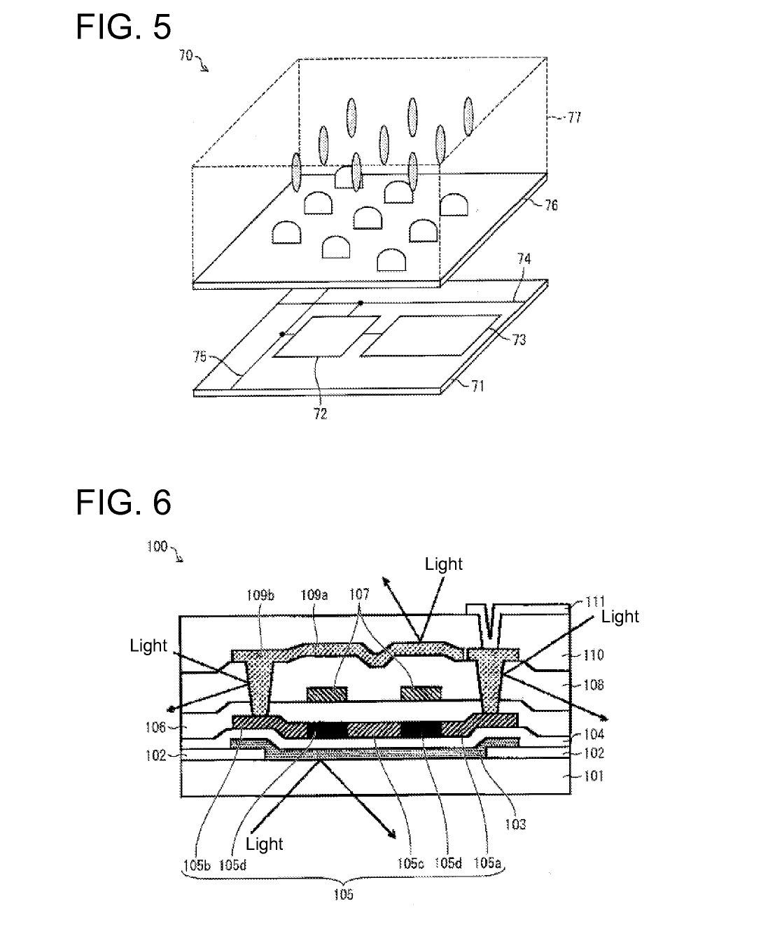

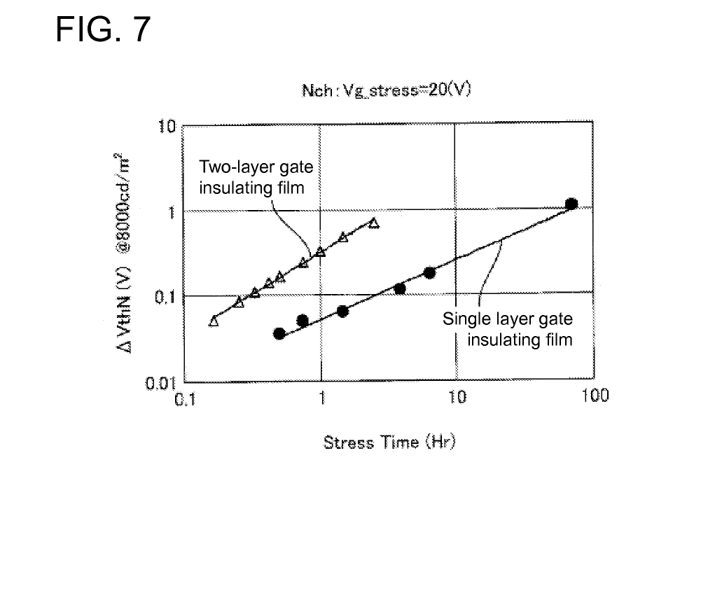

Next, a pixel memory circuit provided in a pixel formation unit in the display section 64 of the liquid crystal display device 60 of the present embodiment is described. FIG. 5 is a conceptual diagram of the pixel formation unit.

In a pixel formation unit 70 of FIG. 5, below a liquid crystal layer 77 for image display, a TFT substrate 71 is disposed so as to interpose a reflective electrode 76 therebetween. Furthermore, a SRAM (storage element) 72 formed of a plurality of thin film transistors and a driver circuit 73 for reversing the alternating current are disposed on the TFT substrate 71. A gate bus line 74 and a source bus line 75 are connected to the SRAM 72.

In this pixel formation unit 70, data can be written directly into the SRAM 72. Therefore, when a still image is displayed, communication between a frame memory and a driver for writing into liquid crystal is not needed. Moreover, alternating current inversion drive can be performed in each pixel formation unit 70. Therefore, charging and discharging of a signal line, which has a heavy load capacitance, are not required either.

Thus, the liquid crystal display device 60 of the present embodiment can reduce the power consumption.

Next, features of the liquid crystal display device 60 of the present embodiment are described.

The liquid crystal display device 60 of the present embodiment is characterized by the configuration of thin film transistors that are respectively equipped in the source driver 62, the gate driver 63, and the memory drive driver 65 (hereinafter, these three drivers may be simply referred to as “driver circuits (driver sections)”), which are driver circuits for controlling image display by the display section 64.

Specifically, in the liquid crystal display device 60 of the present embodiment, the thin film transistors that are respectively equipped in the source driver 62, the gate driver 63, and the memory drive driver 65 have a configuration in which light entering from the surroundings is not directly irradiated onto the gate insulating films of the thin film transistors.

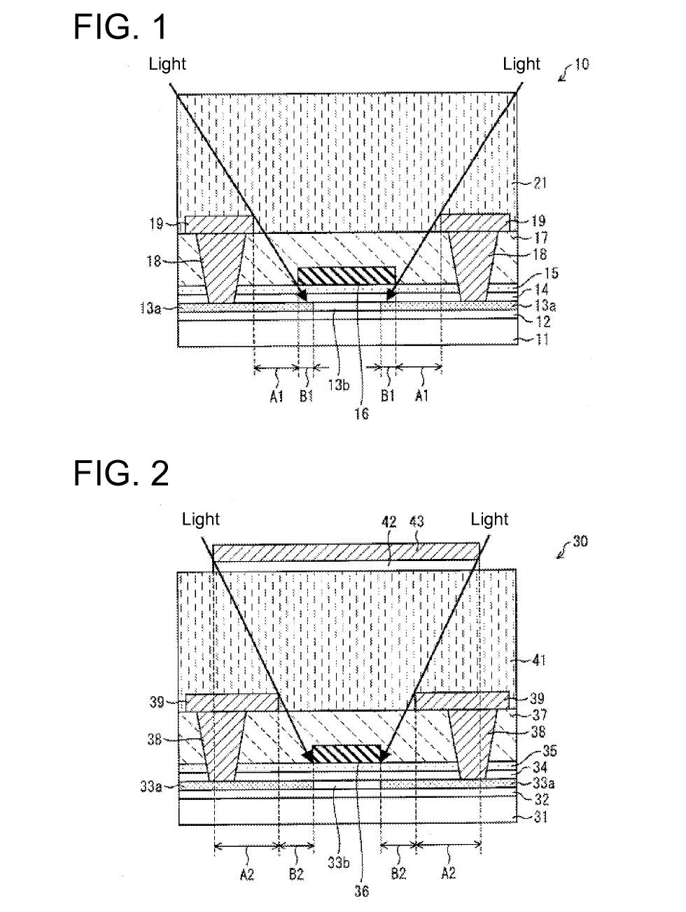

This configuration is described below. FIG. 1 is a cross-sectional view showing a configuration of a thin film transistor constituting a driver circuit of the liquid crystal display device 60 of the present embodiment.

In FIG. 1, this thin film transistor 10 has a substrate 11, a base film 12, planarized films 13a and 13b, a lower layer gate insulating film 14 and an upper layer gate insulating film 15, which constitute a gate insulating film, a gate electrode 16, a first interlayer film 17, connection wires 18, source/drain electrodes 19, and a second interlayer film 21.

For the substrate 11, a glass substrate can be used, for example. The base film 12 has a multilayer configuration of a SiO₂ film and a SiN film, for example, and is disposed between the substrate 11 and the planarized films 13a and 13b. This base film 12 prevents diffusion of mobile ions (sodium ions, for example) from the substrate 11 to the thin film transistor 10. Such a prevention of mobile ion mixing is a very important point in order to ensure the reliability (threshold voltage fluctuation, for example) of the thin film transistor 10.

The planarized films 13a and 13b are polycrystalline Si films that are polycrystallized by irradiating amorphous Si films with laser light, for example. By planarization of the planarized films 13a and 13b, the dielectric breakdown voltage of the gate insulating film can be improved.

Here, as a technique for planarized a silicon film surface, an excimer laser crystallization technique can be used, for example. In this case, a crystallized film having excellent characteristics can be obtained by crystallizing a silicon film in an atmosphere containing oxygen during the first laser crystallization. Generally, the crystallization treatment is completed in this state. Therefore, silicon ridges having substantially the same thickness as the silicon film are formed on the silicon surface.

Then, the second laser crystallization is performed in a non-oxidizing atmosphere (nitrogen atmosphere) to planarize the silicon surface.

As a technique to planarize a silicon surface by a single laser crystallization treatment, a CLC (Continuous Lateral Crystallization) technique, which uses a solid-state laser that can oscillate continuously, is known as well.

The planarized films 13a and 13b can be divided into source/drain regions 13a and a channel region 13b. To form the source/drain regions 13a, an n-type impurity or a p-type impurity is implanted into a polycrystalline Si film using a known ion implantation technique, and the implanted n-type impurity or p-type impurity is activated using a known thermal treatment technique.

Similarly, in order to form the channel region 13b, an n-type impurity or a p-type impurity is implanted into a polycrystalline Si film using a known ion implantation technique, and the implanted n-type impurity or p-type impurity is activated using a known thermal treatment technique. The impurity is implanted into the channel region 13b before the gate electrode 16 is formed.

If this thin film transistor 10 is an n-type transistor, for example, an n-type impurity is implanted into the source/drain regions 13a, whereas a p-type impurity is implanted into the channel region 13b. If this thin film transistor 10 is a p-type transistor, a p-type impurity is implanted into the source/drain regions 13a. No impurity is implanted into the channel region 13b, or alternatively, a p-type impurity is implanted into the channel region 13b.

In a manner similar to the impurity implantation into the channel region 13b, the impurity implantation into the source/drain regions 13a is performed before the gate electrode 16 is formed. This way, the positional relationship between the edges of the gate electrode 16 and the edges of the source/drain regions 13a can be set to satisfy the desired positional relationship, which is described later.

Here, a known gate overlap LDD (Lightly Doped Drain) configuration in which the impurity concentration is low in the portions of the source/drain regions 13a that are overlapped by the gate electrode 16 may be used.

This thin film transistor 10 has a gate insulating film of a two-layer configuration that is formed of the lower layer gate insulating film 14 and the upper layer gate insulating film 15. The lower layer gate insulating film 14 is a SiO₂ film, for example. The upper layer gate insulating film 15 is a SiN film, for example. The relative permittivity of the SiN film is higher than the relative permittivity of the SiO₂ film. Thus, by thickening the upper layer gate insulating film 15, which is formed of an insulating film having the high relative permittivity such as a SiN film, for example, the gate insulating film can be made thick without lowering the capacitance of the gate insulating film.

In the present embodiment, even when silicon ridges are formed during polycrystallization of an amorphous Si film by laser light irradiation, the possibility of such silicon ridges causing a breakdown voltage degradation of the gate insulating film is reduced by thickening the gate insulating film and by planarizing the planarized films 13a and 13b.

Above the upper layer gate insulating film 15, the gate electrode 16 is disposed. For the gate electrode 16, aluminum (Al), molybdenum (Mo), or tungsten (W) is used, for example.

Above the upper layer gate insulating film 15 and the gate electrode 16, the first interlayer film 17 is disposed. For this first interlayer film 17, an inorganic material can be used, for example. Alternatively, a multilayer configuration formed of two layers including a SiN film and a SiO₂ film may be used.

The connection wires 18 electrically connect the source/drain regions 13a to the source/drain electrodes 19. These connection wires 18 are metal wires deposited along the sidewalls of contact holes that are formed so as to run through the lower layer gate insulating film 14, the upper layer gate insulating film 15, and the first interlayer film 17. For the connection wires 18, aluminum (Al) or copper (Cu) is used, for example.

The source/drain electrodes 19 are electrically connected to the source/drain regions 13a through the connection wires 18. For the source/drain electrodes 19, in a manner similar to the connection wires 18, aluminum (Al) or copper (Cu) is used, for example.

Above the first interlayer film 17 and the source/drain electrodes 19, the second interlayer film 21 is disposed. For the second interlayer film 21, a resin is used, for example.

Next, features of the thin film transistor 10 are described.

As shown in FIG. 1, a distance A1 between an edge of the source/drain electrode 19 and an edge of the gate electrode 16 and a distance B1 between an edge of the source/drain region 13a and an edge of the gate electrode 16 are set to satisfy a prescribed relationship.

Specifically, the distances A1 and the distances B1 are set such that light entering from the surroundings does not directly enter the gate insulating film (the lower layer gate insulating film 14 and the upper layer gate insulating film 15) positioned above the channel region 13b.

More specifically, the distances A1 and the distances B1 are set such that light moving toward the channel region 13b without having been blocked by the edges of the source/drain electrodes 19 and the edges of the gate electrode 16 does not directly enter the channel region 13b.

Thus, it can be said that at least one of the gate electrode 16 and the two source/drain electrodes 19 constitutes a light shielding film for blocking external light in order to prevent external light entering the liquid crystal display device 60 from the surroundings of the liquid crystal display device 60 from entering the gate insulating film (the lower layer gate insulating film 14 and the upper layer gate insulating film 15) located above the channel region 13b.

Of the gate insulating film, the portion located above the channel region 13b corresponds to the effective gate insulating film of this thin film transistor 10. Therefore, if light is prevented from directly entering the channel region 13b, light can be also prevented from entering this effective gate insulating film.

Therefore, in the thin film transistor 10, light entering into the gate insulating film can be prevented, and light degradation of the gate insulating film caused by light irradiation can be suppressed.

As described above, in Embodiment 1 of the present invention, light degradation of the gate insulating film of the thin film transistor 10 equipped in the driver circuit caused by incident light can be prevented, and a multilayer configuration of the gate insulating film can be achieved.

Thus, the threshold voltage of the thin film transistor 10, which is equipped in the driver circuit, is lowered. This way, the thin film transistor 10 of the driver circuit can be driven at a low power supply voltage, and a low power consumption can be achieved.

### Embodiment 2

Next, Embodiment 2 according to the present invention is described. In the above-mentioned Embodiment 1, blocking of light moving toward the channel region was performed by using the edges of the gate electrode and the edges of the source/drain electrodes.

In contrast, the present embodiment is an embodiment in which light is blocked using, edges of an opposite electrode in addition to the edges of the gate electrode and the edges of the source/drain regions.

FIG. 2 is a cross-sectional view showing a configuration of a thin film transistor that constitutes a driver circuit of a liquid crystal display device according to the present embodiment.

In FIG. 2, this thin film transistor 30 has a substrate 31, a base film 32, planarized films 33a and 33b, a lower layer gate insulating film 34 and an upper layer gate insulating film 35, which constitute a gate insulating film, a gate electrode 36, a first interlayer film 37, connection wires 38, source/drain electrodes 39, a second interlayer film 41, a transparent electrode 42, and a reflective electrode 43.

For the substrate 31, a glass substrate can be used, for example. The base film 32 has a multilayer configuration of a SiO₂ film and a SiN film, for example, and is disposed between the substrate 31 and the planarized films 33a and 33b.

The planarized films 33a and 33b are polycrystalline Si films that are polycrystallized by irradiating amorphous Si films with laser light. The planarized films 33a and 33b can be divided into source/drain regions 33a and a channel region 33b. In order to form source/drain regions 33a, an n-type impurity or a p-type impurity is implanted into polycrystalline Si films using a known ion implantation technique, and the implanted n-type impurity or p-type impurity is activated by a known thermal diffusion technique.

Similarly, in order to form the channel region 33b, an n-type impurity or a p-type impurity is implanted into the polycrystalline Si film using a known ion implantation technique, and the implanted n-type impurity or p-type impurity is activated using a known thermal treatment technique. The impurity is implanted into the channel region 33b before the gate electrode 36 is formed.

If this thin film transistor 30 is an n-type transistor, for example, an n-type impurity is implanted into the source/drain regions 33a, whereas a p-type impurity is implanted into the channel region 33b. If this thin film transistor 30 is a p-type transistor, a p-type impurity is implanted into the source/drain regions 33a, whereas no impurity is implanted into the channel region 33b, or alternatively, a p-type impurity is implanted into the channel region 33b.

Unlike Embodiment 1 mentioned above, the impurity implantation into source/drain regions 33a can be performed after the gate electrode 36 has been formed. By doing so, edges of the gate electrode 36 and edges of the source/drain regions 33a can be aligned in a self-aligned manner. Therefore, the positional alignment of the edges of the gate electrode 36 and the edges of the source/drain regions 33a can be performed accurately. As a result, transistor characteristics of the thin film transistor 30 can be improved.

This thin film transistor 30 has a gate insulating film of a two-layer configuration formed of the lower layer gate insulating film 34 and the upper layer gate insulating film 35. The lower layer gate insulating film 34 is a SiO₂ film, for example. The upper layer gate insulating film 35 is a SiN film, for example. The relative permittivity of the SiN film is higher than the relative permittivity of the SiO₂ film. By thickening the upper layer gate insulating film 35, which is formed of an insulating film having a high relative permittivity such as a SiN film, for example, the gate insulating film can be thickened without lowering the capacitance of the gate insulating film.

The planarized films 33a and 33b are planarized above the substrate 31.

In the present embodiment, by thickening the gate insulating film and by planarizing the planarized films 33a and 33b, the possibility of them becoming factors to cause breakdown voltage degradation of the gate insulating film is reduced.

The gate electrode 36 is disposed above the upper layer gate insulating film 35. For the gate electrode 36, aluminum (Al), molybdenum (Mo), or tungsten (W) is used, for example.

The first interlayer film 37 is disposed above the upper layer gate insulating film 35 and the gate electrode 36. For this first interlayer film 37, an inorganic material is used, for example. Alternatively, a multilayer configuration constituted of two layers including a SiN film and a SiO₂ film may be used.

The connection wires 38 electrically connects the source/drain regions 33a to the source drain electrodes 39. These connection wires 38 are metal wires deposited along sidewalls of contact holes that are formed so as to run though the lower layer gate insulating film 34, the upper layer gate insulating film 35, and the first interlayer film 37. For the connection wires 38, aluminum (Al) or copper (Cu) is used, for example.

The source/drain electrodes 39 are electrically connected to the source/drain regions 33a through the connection wires 38. For the source/drain electrodes 39, in a manner similar to the connection wires 38, aluminum (Al) or copper (Cu) is used, for example.

The second interlayer film 41 is disposed above the first interlayer film 37 and the source/drain electrodes 39. For the second interlayer film 41, a resin is used, for example.

The transparent electrode 42 and the reflective electrode 43 are disposed above the second interlayer film 41. Normally, the transparent electrode 42 and the reflective electrode 43 would not be required for the thin film transistors respectively used in a source driver 62, a gate driver 63, and a memory drive driver 65. In the present embodiment, however, entering of light into the gate insulating film can be performed more securely by using a transparent electrode and a reflective electrode for the thin film transistors of a display section 64 in the thin film transistor of the driver circuit. For the transparent electrode 42, ITO can be used, for example. For the reflective electrode 43, aluminum (Al) can be used, for example.

Next, features of the thin film transistor 30 are described.

As shown in FIG. 2, a distance A2 between an edge of the reflective electrode 43 and an edge of the source/drain electrode 39 and a distance B2 between an edge of the source/drain electrode 39 and an edge of the gate electrode 36 are set to satisfy a prescribed relationship.

Specifically, the distances A2 and the distances B2 are set such that light entering from the surroundings does not directly enter the gate insulating film (the lower layer gate insulating film 34 and the upper layer gate insulating film 35) located above the channel region 33b.

More specifically, the distances A2 and the distances B2 are set such that light moving toward the channel region 33b without having been blocked by edges of the reflective electrode 43, the edges of the source/drain electrodes 39, or the edges of the gate electrode 36 does not directly enter the channel region 33b.

Thus, it can be said that at least one of the gate electrode 36, the two source/drain electrodes 39, and the reflective electrode 43 constitutes a light shielding film in order to prevent external light entering the liquid crystal display device from the surroundings of the liquid crystal display device from entering the gate insulating film (the lower layer gate insulating film 34 and the upper layer gate insulating film 35) located above the channel region 33b.

Of the gate insulating film, the portion located above the channel region 33b corresponds to the effective gate insulating film of this thin film transistor 30. Therefore, if light does not directly enter the channel region 33b, light entering this effective gate insulating film can be prevented as well.

Therefore, in the thin film transistor 30, light entering into the gate insulating film can be prevented, and light degradation of the gate insulating film caused by light irradiation can be suppressed.

As described above, in Embodiment 2 of the present invention, light degradation of the gate insulating film of the thin film transistor 30 equipped in the driver circuit caused by incident light can be prevented more effectively, and a multilayer configuration of the gate insulating film can be achieved.

As a result, the threshold voltage of the thin film transistor 30 equipped in the driver circuit can be lowered more securely. This way, the thin film transistor 30 of the driver circuit can be driven at a low power supply voltage, and a low power consumption can be achieved.

Furthermore, because the source/drain regions 33a can be formed in a self-aligned manner with respect to the gate electrode 36, transistor characteristics of the thin film transistor 30 can be improved.

### Embodiment 3

Next, Embodiment 3 according to the present invention is described. Embodiment 2 mentioned above is an embodiment in which light is blocked using the edges of the gate electrode, the edges of the source/drain regions and the edges of the reflective electrode. The present embodiment is an embodiment in which the reflective electrode of Embodiment 2 mentioned above is disposed only in a transistor formation region of a driver circuit.

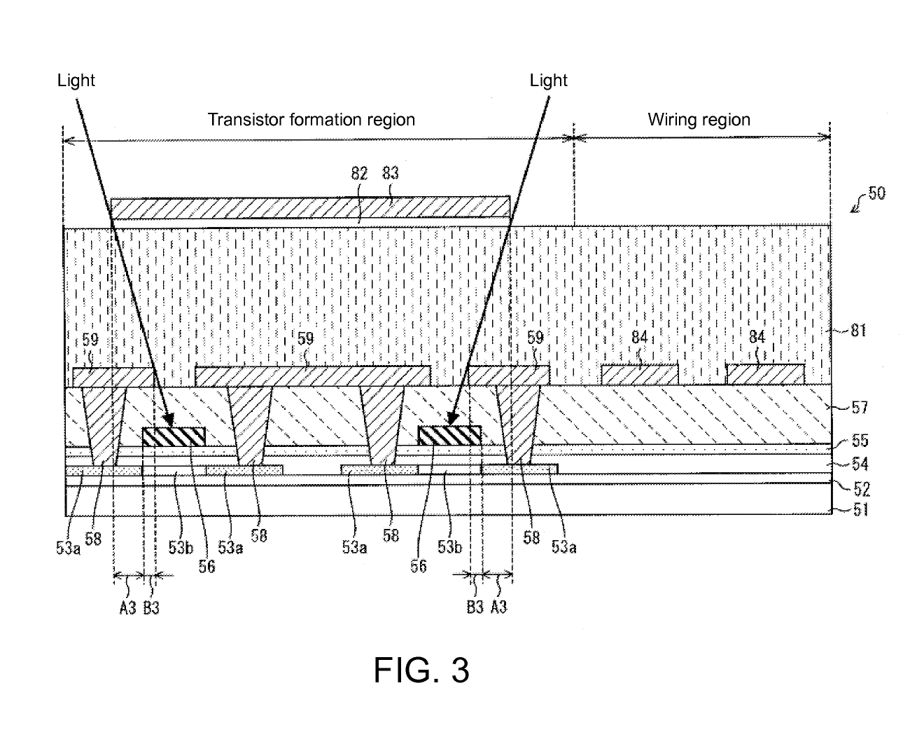

FIG. 3 is a cross-sectional view showing a configuration of a portion of a driver circuit in a liquid crystal display device according to the present embodiment. As shown in FIG. 3, a plurality of thin film transistors are formed in a transistor formation region. In a wiring region, a plurality of metal wires for connecting the plurality of thin film transistors in the transistor formation region together are formed. Here, the transistor formation region is a region including a silicon film formation region of the transistor and a surrounding region extending approximately 5 μm from the silicon film formation region of the transistor, for example.

In FIG. 3, this driver circuit 50 has a substrate 51, a base film 52, planarized films 53a and 53b, a lower layer gate insulating film 54 and an upper layer gate insulating film 55, which constitute a gate insulating film, gate electrodes 56, a first interlayer film 57, connection wires 58, source/drain electrodes 59, a second interlayer film 81, a transparent electrode 82, a reflective electrode (reflective layer) 83, and lead-out wires 84.

For the substrate 51, a glass substrate can be used, for example. The base film 52 has a multilayer configuration of a SiO₂ film and a SiN film, for example, and is disposed between the substrate 51 and the planarized films 53a and 53b.

The planarized films 53a and 53b are polycrystalline Si films polycrystallized by irradiating amorphous Si films with laser light, for example. Furthermore, the planarized films 53a and 53b can be divided into source/drain regions 53a and channel regions 53b. In order to form the source/drain regions 53a, an n-type impurity or a p-type impurity is implanted into polycrystalline Si films using a known ion implantation technique, and the implanted n-type impurity or p-type impurity is activated using a known thermal treatment technique.

Similarly, in order to form the channel regions 53b, an n-type impurity or a p-type impurity is implanted into polycrystalline Si films using a known ion implantation technique, and the implanted n-type impurity or p-type impurity is activated using a known thermal diffusion technique. The impurity is implanted into the channel regions 53b before the gate electrodes 56 are formed.

If the thin film transistors formed in the transistor formation region of the driver circuit 50 are n-type transistors, for example, an n-type impurity is implanted into the source/drain regions 53a, whereas a p-type impurity is implanted into the channel regions 53b. If the thin film transistors of the driver circuit 50 are p-type transistors, a p-type impurity is implanted into the source/drain regions 53a, whereas no impurity is implanted into the channel regions 53b, or alternatively, a p-type impurity is implanted into the channel regions 53b.

The impurity can be implanted into the source/drain regions 53a after the gate electrodes 56 have been formed. By doing so, edges of the gate electrodes 56 and edges of the source/drain regions 53a can be aligned in a self-aligned manner. Therefore, positional alignment of the edges of the gate electrodes 56 and the edges of the source/drain regions 53a can be performed accurately. As a result, transistor characteristics of the thin film transistors of the driver circuit 50 can be improved.

These thin film transistors have a gate insulating film of two-layer configuration, which is formed of the lower layer gate insulating film 54 and the upper layer gate insulating film 55. The lower layer gate insulating film 54 is a SiO₂ film, for example. The upper layer gate insulating film 55 is a SiN film, for example. The relative permittivity of the SiN film is higher than the relative permittivity of the SiO₂ film. By thickening the upper layer gate insulating film 55, which is formed of an insulating film having a high relative permittivity such as a SiN film, for example, the gate insulating film can be thickened without lowering the capacitance of the gate insulating film.

The planarized films 53a and 53b are planarized above the substrate 51.

In the present embodiment, by thickening the gate insulating film and by planarizing the planarized films 53a and 53b, the possibility of them becoming factors to cause breakdown voltage degradation of the gate insulating film is reduced.

The gate electrodes 56 are disposed above the upper layer gate insulating film 55. For the gate electrodes 56, a film of aluminum (Al), molybdenum (Mo), or tungsten (W) is used, for example.

The first interlayer film 57 is disposed above the upper layer gate insulating film 55 and the gate electrodes 56. For this first interlayer film 57, an inorganic material can be used, for example. Alternatively, a multilayer configuration formed of two layers including a SiN film and a SiO₂ film can be used.

The connection wires 58 electrically connect the source/drain regions 53a to the source/drain electrodes 59. These connection wires 58 are metal wires deposited along sidewalls of contact holes that are formed so as to run through the lower layer gate insulating film 54, the upper layer gate insulating film 55, and the first interlayer film 57. For the connection wires 58, aluminum (Al) or copper (Cu) is used, for example.

The source/drain electrodes 59 are electrically connected to the source/drain regions 53a through the connection wires 58. For the source/drain electrodes 59, in a manner similar to the connection wires 58, aluminum (Al) or copper (Cu) is used, for example.

The lead-out wires 84 are formed in the wiring region using the same wires as these source/drain electrodes 59.

The second interlayer film 81 is disposed above the first interlayer film 57, the source/drain electrodes 59, and the lead-out wires 84. For the second interlayer film 81, a resin is used, for example.

The transparent electrode 82 and the reflective electrode 83 are disposed above the second interlayer film 81. Normally, the transparent electrode 82 and the reflective electrode 83 would not be required for thin film transistors used in the source driver 62, the gate driver 63, and the memory drive driver 65, respectively. In the present embodiment, however, entering of light into the gate insulating film can be performed more securely by using the transparent electrode and the reflective electrode for the thin film transistors of the display section 64 in the thin film transistors of the driver circuit. For the transparent electrode 82, ITO can be used, for example. For the reflective electrode 83, aluminum (Al) can be used, for example.

Thus, the thin film transistors of the driver circuit 50 have the reflective electrode 83, which uses the same wiring layer as the reflective electrode of the thin film transistors of the display section 64. The reflective electrode 83 is disposed only in the transistor formation region of the driver circuit 50.

As shown in FIG. 3, a distance A3 between an edge of the reflective electrode 83 and an edge of the gate electrodes 56 and a distance B3 between an edge of the source/drain electrodes 59 and an edge of the gate electrodes 56 are set to satisfy a prescribed relationship.

Specifically, the distances A3 and the distances B3 are set such that light entering from the surroundings does not directly enter the gate insulating film (the lower layer gate insulating film 54 and the upper layer gate insulating film 55) located above the channel regions 53b.

More specifically, the distances A3 and the distances B3 are set such that light moving toward the channel regions 53b without having been blocked by edges of the reflective electrode 53, edges of the source/drain electrodes 59, or edges of the gate electrodes 56 does not directly enter the channel regions 53b.

Thus, it can be said that, in order to prevent external light entering the liquid crystal display device from the surroundings of the liquid crystal display device from entering the gate insulating film (the lower layer gate insulating film 54 and the upper layer gate insulating film 55) located above the channel regions 53b, at least one of the gate electrodes 56, the two source/drain electrodes 59, and the reflective electrode 53 constitutes a light shielding film.

Of the gate insulating film, portions located above the channel regions 53b correspond to the effective gate insulating film of the thin film transistors of FIG. 3. Therefore, if light does not directly enter the channel regions 53b, light can be prevented from entering the effective gate insulating film as well.

Thus, the thin film transistors of FIG. 3 can prevent light from entering the gate insulating film, and light degradation of the gate insulating film caused by light irradiation can be suppressed.

In the present embodiment, the transparent electrode 82 and the reflective electrode 83 are formed in the transistor formation region, and are not formed in the wiring region. In the wiring region, the plurality of lead-out wires 84 are formed. As described above, a metal material is used for these lead-out wires 84. Therefore, if the transparent electrode 82 and the reflective electrode 83 are disposed above the second interlayer film 81, the transparent electrode 82, the reflective electrode 83, and the lead-out wires 84 form wiring capacitances between them. These wiring capacitances cause defects such as mutual interferences between the lead-out wires 84 and delay of the propagation velocity of the lead-out wires 84.

Because of this, in the present embodiment, such defects are avoided and degradation of the operation speed of the driver circuit is prevented by not forming the transparent electrode 82 and the reflective electrode 83 in the wiring region.

As described above, in Embodiment 3 of the present invention, light degradation of the gate insulating film of the thin film transistors equipped in the driver circuit 50 caused by incident light can be prevented more effectively, and a multilayer configuration of the gate insulating film can be achieved.

As a result, the threshold voltage of the thin film transistors equipped in the driver circuit 50 can be lowered more securely. This way, the thin film transistors of the driver circuit 50 can be driven at a low power supply voltage, and a low power consumption can be reduced.

Furthermore, transistor characteristics of the thin film transistors can be improved because the source/drain regions 53a can be formed in a self-aligned manner with respect to the gate electrodes 56.

Furthermore, according to the present embodiment, the above-mentioned effects can be achieved without degrading the operation speed of the driver circuit 50.

The present invention is not limited to the above-mentioned respective embodiments, and various modifications are possible within the scope set forth in claims. Embodiments obtained by appropriately combining technical means that are respectively described in different embodiments are also included in the technical scope of the present invention.

The present invention is the most effective when it is applied in a reflective liquid crystal display device. However, it is also effective for lowering the voltage of a driver circuit and for the superior reliability in other display devices, such as a transmissive liquid crystal display device, an organic EL display device, and the like.

In the case of the transmissive liquid crystal display device, degradation caused by light becomes a problem particularly in transistors of a driver circuit rather than in transistors of a display section. This is because, in the display section, the period during which ON state signals are inputted into gate electrodes of the transistors is one divided by the number of gate bus lines, i.e., a several hundredth part, whereas in the peripheral circuit, there exist transistors having gate electrodes into which ON state signals are inputted during 99% of the time or more. Therefore, disposing a light shielding film below the transistors of the peripheral circuit is important, and that is the reason that the application of the present invention is effective.

The present invention can also be described as follows. A liquid crystal display device according to the present invention is a reflective liquid crystal display device, including a display section having a plurality of pixels for displaying an image arranged and a driver section for controlling image display by the display section. Each of the plurality of pixels has a storage element for storing a display signal. The driver section is constituted of a plurality of thin film transistors, and each of the plurality of thin film transistors includes the following: a channel region and two source/drain regions arranged to have the channel region therebetween; a gate insulating film that is disposed at least above the channel region and that is formed of a multilayer configuration having a plurality of films; a gate electrode disposed above the gate insulating film; two source/drain electrodes electrically connected to the two source/drain regions, respectively, through a connection wire that runs through the gate insulating film and a first interlayer film disposed over the gate insulating film; and a light shielding film that prevents external light entering the liquid crystal display device from surroundings of the liquid crystal display device from entering a portion of the gate insulating film disposed above the channel region, thereby blocking the external light.

In the above-mentioned liquid crystal display device, a light shielding film for blocking external light is provided for the respective plurality of thin film transistors constituting the driver section to prevent external light entering from the surroundings of the liquid crystal display device from entering a portion of the gate insulating film disposed above the channel region.

As a result, light irradiation onto the gate insulating film can be prevented. Therefore, the gate insulating film can be formed of a multilayer configuration of a plurality of films, and the threshold voltage of the thin film transistors can be lowered. This way, the power supply voltage of the driver section can be lowered, and the power consumption can be reduced. Thus, a liquid crystal display device that can be driven with a low power supply voltage and that can reduce the power consumption can be achieved.

The aforementioned light shielding film preferably is one of the gate electrode and the two source/drain electrodes.

In this case, if the light shielding film is the gate electrode, the gate electrode can be formed after the two source/drain regions have been formed. Therefore, the gate electrode can be disposed to match the channel region, which is interposed between the source/drain regions. As a result, light entering a portion of the gate insulating film disposed above the channel region can be securely blocked.

Alternatively, if the light shielding film is the two source/drain electrodes, the two source/drain regions can be formed in a self-aligned manner with respect to the gate electrode.

The aforementioned display section preferably has a reflective electrode that reflects the aforementioned external light to generate light used for image display by the aforementioned display section. Each of the aforementioned plurality of thin film transistors preferably has a reflective film that uses the same wiring layer as the reflective electrode of the aforementioned display section. The aforementioned light shielding film preferably is at least one of the aforementioned gate electrode, the aforementioned two source/drain electrodes, and the aforementioned reflective film.

In this case, if the light shielding film is the reflective film, the light shielding film can be formed to extend in a large region, and entering of light can be blocked more securely.

If the light shielding film is the gate electrode, the gate electrode can be formed after the two source/drain regions have been formed. Therefore, the gate electrode can be disposed to match the channel region, which is interposed between the source/drain regions. As a result, light entering a portion of the gate insulating film disposed above the channel region can be blocked securely.

If the light shielding film is the two source/drain electrodes, the two source/drain regions can be formed in a self-aligned manner with respect to the gate electrode.

The aforementioned reflective film is preferably disposed only in the transistor formation region of the aforementioned driver section.

In this case, delay in signal propagation in the wiring region of the driver section can be prevented. Thus, the driver section can operate at fast speed.

The aforementioned channel region and the aforementioned two source/drain regions preferably are formed in a planarized silicon film. The aforementioned planarized silicon film preferably has a recess and a protrusion having half or less of the thickness of the silicon film on a surface on a side of the aforementioned gate insulating film.

In this case, the dielectric breakdown voltage of the gate insulating film disposed above the channel region and the two source/drain regions can be improved further.

Further, the present invention can be described as follows. A reflective liquid crystal display device according to the present invention is a reflective liquid crystal display device that has a memory circuit for storing a display signal in a pixel. A gate insulating film of a thin film transistor constituting a circuit and a switching element has a two-layer configuration. A silicon film side is formed of a silicon dioxide film, and a gate electrode side is formed of a film that has a higher permittivity than the silicon dioxide film. A film for blocking external light is formed above the channel of the thin film transistor and above the gate insulating film above the source/drain edges, which are located next to the channel.

The aforementioned light shielding film for external light preferably is formed of a gate electrode.

The aforementioned light shielding film for external light preferably is formed of source/drain electrodes, and the source electrode and the drain electrode preferably are formed to respectively overlap the gate electrode.

The aforementioned light shielding film for external light preferably is formed in the same layer as a pixel reflective electrode.

The aforementioned light shielding film for external light preferably is formed only in a transistor formation region, and preferably is not formed in signal wiring and power supply wiring regions.

External light preferably is blocked using two or more of the aforementioned light shielding films for external light.

In the aforementioned thin film transistor, the recess and the protrusion (silicon ridges) on a surface of the silicon film preferably have half the thickness of the silicon film or less.

### INDUSTRIAL APPLICABILITY

A liquid crystal display device of the present invention can be suitably used in portable devices, personal computers, and video cameras.

### DESCRIPTION OF REFERENCE CHARACTERS

10, 30 thin film transistors
11, 31, 51 substrates
12, 32, 52 base films
13a, 33a, 53a source/drain regions
13b, 33b, 53b channel regions
14, 34, 54 lower layer gate insulating films
15, 35, 55 upper layer gate insulating films
16, 36, 56 gate electrodes
17, 37, 57 first interlayer films
18, 38, 58 connection wires
19, 39, 59 source/drain electrodes
21, 41, 81 second interlayer films
42, 82 transmissive electrodes
43, 76 reflective electrodes
50 driver circuit (driver section)
60 liquid crystal display device
61 liquid crystal display panel
62 source driver (driver section)
63 gate driver (driver section)
64 display section
65 memory drive driver
66 display control circuit
67 memory drive control unit
70 pixel formation unit (pixel)
71 TFT substrate
72 SRAM (storage element)
73 alternating current inversion driver circuit
74 gate bus line
75 source bus line
77 liquid crystal layer
83 reflective electrode (reflective layer)
84 lead-out wire
100 liquid crystal display device
101 insulating substrate
102 step formation film
103 light shielding film
104 buffer layer
105 semiconductor film
105a source region
105b drain region
105c hybrid region
105d channel region
106 gate insulating film
107 gate electrode
108 interlayer insulating film
109a source electrode
109b drain signal line
110 planarized film
111 pixel electrode

1. A reflective liquid crystal display device, comprising:
a display section having a plurality of pixels for displaying an image arranged; and
a driver section for controlling image display by said display section, each of said plurality of pixels having a storage element for storing a display signal,
wherein said driver section is constituted of a plurality of thin film transistors, and
wherein each of said plurality of thin film transistors includes:
a channel region and two source/drain regions arranged to have said channel region therebetween;
a gate insulating film that is disposed at least above said channel region and that is formed of a multilayer configuration having a plurality of films;
a gate electrode disposed above said gate insulating film;
two source/drain electrodes electrically connected to said two source/drain regions, respectively, through connection wires that run through said gate insulating film and a first interlayer film disposed over said gate insulating film; and
a light shielding film that prevents external light entering said liquid crystal display device from surroundings of said liquid crystal display device from entering a portion of said gate insulating film disposed above said channel region, thereby blocking said external light.

2. The liquid crystal display device according to claim 1, wherein said light shielding film is at least one of said gate electrode and said two source/drain electrodes.

3. The liquid crystal display device according to claim 1, wherein said display section has a reflective electrode that reflects said external light to generate light to be used for image display by said display section, and
wherein each of said plurality of thin film transistors has a reflective film that uses a same wiring layer as the reflective electrode of said display section, and said light shielding film is at least one of said gate electrode, said two source/drain electrodes, and said reflective film.

4. The liquid crystal display device according to claim 3, wherein said reflective film is disposed only in a transistor formation region of said driver section.

5. The liquid crystal display device according to claim 1, wherein said channel region and said two source/drain regions are formed in a planarized silicon film.

6. The liquid crystal display device according to claim 5, wherein said planarized silicon film has a recess and a protrusion of half or less of its thickness on a surface on a side of said gate insulating film.
